(19) United States
(12) Patent Application Publication
(10) Pub. No.: US 2009/0123802 A1
(43) Pub. Date: May 14, 2009

(54) FUEL CELL HAVING MOISTURE SENSOR DEVICE

(76) Inventors: YUNG-LIEH CHIEN, Chupei (TW); Ming-Yao Dong, Chupei (TW)

Correspondence Address: G. LINK CO., LTD., 3550 BELL ROAD, MINOOKA, IL, 60447, US

(21) Appl. No.: 12/013,455

(22) Filed: Jan. 13, 2008

(30) Foreign Application Priority Data
Nov. 12, 2007 (TW) 096142714

(51) Int. Cl. H01M 8/02

(52) U.S. Cl. 429/26; 429/12

(57) ABSTRACT

The present invention relates to a fuel cell having moisture sensor device. The fuel cell comprises a power generation structure that consists of a circuit board; a membrane electrode assembly arranged on the circuit board; and a moisture sensor unit comprising a first sensing member and a second sensing member. The first sensing member and the second sensing member are electrically connected to the circuit board and disposed on the circuit board such that they produce capacitance effect.

### FIELD OF THE INVENTION

The present invention relates to a fuel cell having moisture sensor device, particularly a kind of fuel cell that can measure moisture.

### BACKGROUND OF THE INVENTION

In a fuel cell system that uses hydrogen-rich fuel (e.g. methanol) and oxygen fuel to undergo electrochemical reaction and output power, it is necessary for users to know when to replenish the fuel when fluid concentration or level becomes low. Thus it is necessary to detect the fluid fuel level and volume in the fuel container. While technological advances have rendered fuel cells more efficient, more problems arise.

One of the problems arising is moisture change in the fuel cell. The power generation device in fuel cells comprises a plurality of circuit boards arranged in stack. As the power generation device faces greater demand and generates more power, moisture generated thereof increases. If the area surrounding the circuit boards is not well ventilated, moisture tends to aggregate. Under the dual actions of moisture and thermal energy, there is concern for the acceleration of oxidation of circuit boards and other metallic components of the fuel cell, which tends to lead to poor power supply efficiency and poor contact. If the moisture is high enough to form dews, it might cause near short-circuit between electrodes. Thus fuel cells are typically installed with a fan to expel moisture. In the conventional design, the fan will be working all the time regardless of the moisture content in the power generation device, that is, the fan is forced to expel moisture without knowing whether the moisture inside has exceeded a set range.

In light of the drawbacks of conventional fuel cells, the inventor aims to develop a product that meets the current needs.

### SUMMARY OF THE INVENTION

The object of the invention is to provide a fuel cell having moisture sensor device that employs a moisture sensor unit installed to measure change in moisture.

The present invention relates to a fuel cell having moisture sensor device. The fuel cell comprises a power generation structure that consists of a circuit board; a membrane electrode assembly arranged on the circuit board; and a moisture sensor unit comprising a first sensing member and a second sensing member. The first sensing member and the second sensing member are electrically connected to the circuit board and disposed on the circuit board such that they produce capacitance effect.

The objects, features and effects of the invention are described in detail below with embodiments in reference to the accompanying drawings.

### BRIEF DESCRIPTION OF THE DRAWINGS

FIG. 1 is a perspective view of a first embodiment of the invention;

FIG. 2 is a perspective view of a second embodiment of the invention;

FIG. 3 is a side view of FIG. 2;

FIG. 4 is an exploded view of a third embodiment of the invention;

FIG. 5 is a perspective view of a fourth embodiment of the invention;

FIG. 6 is a side view of FIG. 5;

FIG. 7 is a perspective view of a fifth embodiment of the invention;

FIG. 8 is a perspective view of a sixth embodiment of the invention;

FIG. 9 is a side view of FIG. 8;

FIG. 10 is a circuit diagram of the invention; and

FIG. 11 is a perspective view of a seventh embodiment of the invention.

### DETAILED DESCRIPTION OF THE INVENTION

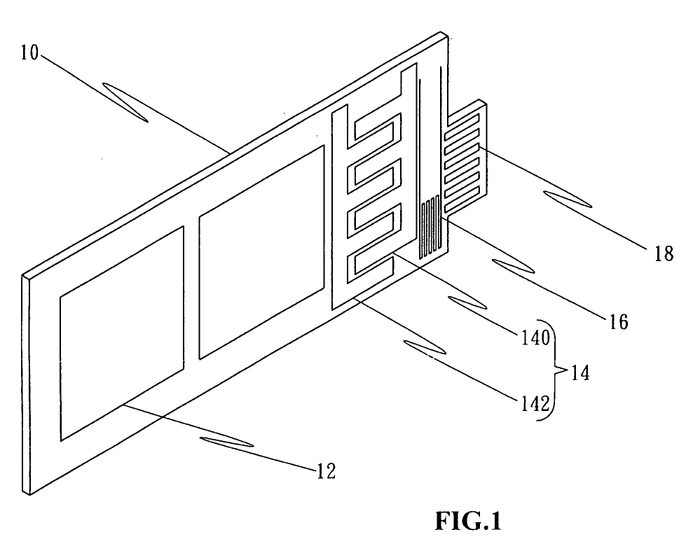

FIG. 1 is a perspective view of a first embodiment of the invention. As shown, the fuel cell having moisture sensor device according to the invention comprises a circuit board (10), and at least a membrane electrode assembly (12), a moisture sensor unit (14), and a temperature sensor unit (16) arranged on the circuit board (10). The circuit board (10) is a common circuit board; the membrane electrode assembly (12) is the core power generation component of the fuel cell and a polymer membrane coated with platinum (Pt)-containing catalyst on the two side surfaces to form anode and cathode, the anode side being in contact with the hydrogen-containing fuel, while the cathode side being in contact with oxygen in the air, the membrane electrode assembly (12) undergoing chemical reaction under the action of catalyst and directly generating power for output, the membrane electrode assembly (12) being disposed on the circuit board (10) and having a porous electrically conductive net on its left and right sides respectively as the power collector network for power output; the moisture sensor unit (14) comprises a first sensing member (140) and a second sensing member (142), the first sensing member (140) and the second sensing member (142) being disposed on the circuit board (10) and having respectively in horizontal direction a plurality of sidewardly extended strip lines that are alternately arranged to produce capacitance effect; and a temperature sensor unit (16) made of conductive metal material to form an electrical construction with resistance effect or a heat-sensitive resistor and disposed on the circuit board (10).

The equivalent resistor in the temperature sensor unit (16) can be a conductive line made of metallic material, such as aluminum, gold or copper, or a high-resistance circuit made of metallic material, such as nickel or chromium. Take the example of conductive line, the temperature sensor unit (16) is made of common printed circuit board or formed by etching that endows the temperature sensor unit (16) considerable resistance property. Based en the interdependence between the resistance of its conductive line and temperature, the temperature sensor unit (16) obtains the temperature surrounding it by sensing the resistance of the conductive line. In addition, higher resistance of the temperature sensor unit (16) can enhance the resolution of temperature sensing. Thus, the conductive line of the temperature sensor unit (16) can be disposed on the circuit board (10) in a circuitous manner to extend its length.

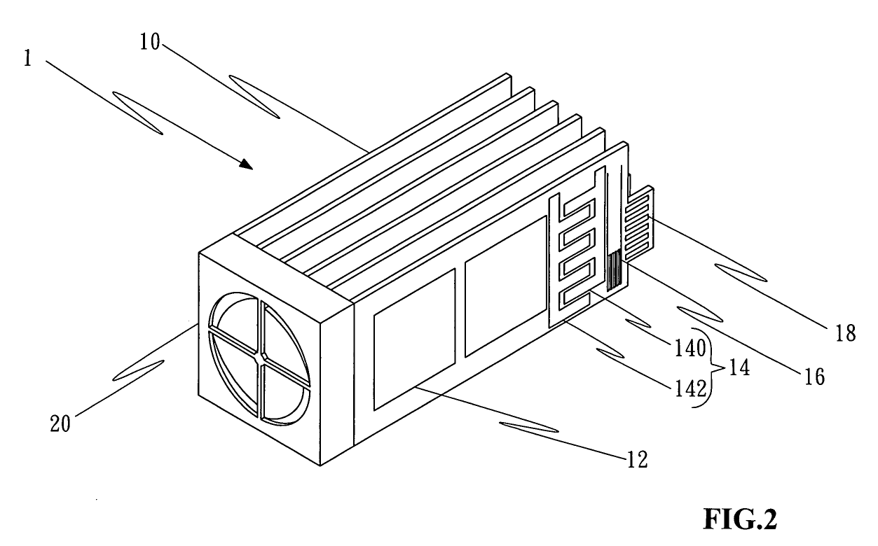

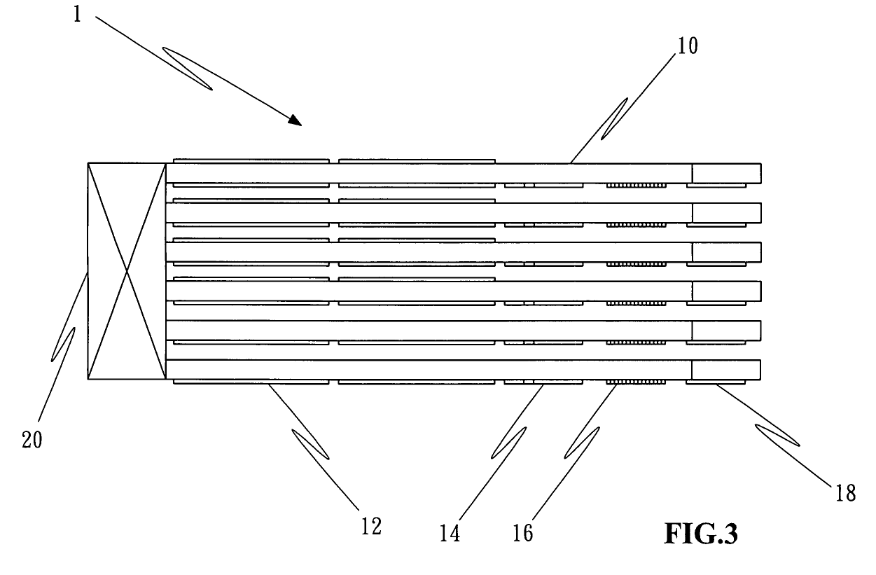

FIG. 2 is a perspective view of a second embodiment of the invention; FIG. 3 is a side view of FIG. 2. As shown, the fuel cell with moisture sensor device according to the invention further comprises a plurality of circuit boards (10) to form a power generation structure (1). The plurality of circuit boards (10) are parallel to each other and arranged in alternative stack to form the power generation structure (1), and a heat sink (20) is disposed at one end of the power generation structure (1) to provide active heat dissipation and the motive power for oxygen supply.

The circuit broad (10) is extended with a connector (18) at one end. The connector (18) can transmit the signal on the change in capacitance and the change in resistance sent out by respectively the moisture sensor unit (14) and the temperature sensor unit (16). In the case where the heat sink (20) is a fan, an electric signal on the capacitance of the moisture sensor unit (14) and the resistance of the temperature sensor unit (16) as measured or processed is sent to the heat sink (20) via the connector (18). The heat sink (20) installed on one side of the circuit board (10) will adjust its fan speed based on the electric signal received to keep the overall moisture and temperature within a range.

The electric signal on the capacitance of the moisture sensor unit (14) or the resistance of the temperature sensor unit (16) can also directly regulate the fan speed of the heat sink (20) through a common electric loop, thereby regulating the moisture and temperature of the power generation structure (1).

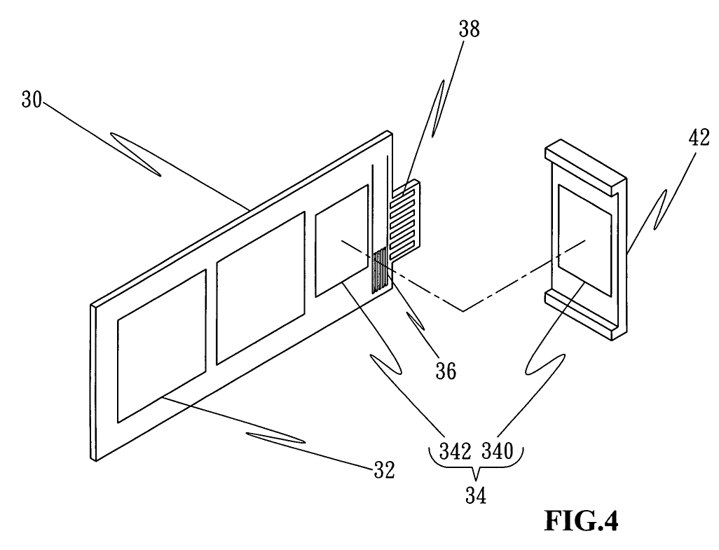

FIG. 4 is an exploded view of a third embodiment of the invention. The fuel cell having moisture sensor device according to the invention comprises a circuit board (30), and at least a membrane electrode assembly (32), a moisture sensor unit (34), a temperature sensor unit (36) and a plate body (42) arranged on the circuit board (30). The circuit board (30) is a common circuit board; the membrane electrode assembly (32) is the core power generation component of the fuel cell and a polymer membrane coated with platinum (Pt)-containing catalyst on the two side surfaces to form anode and cathode, the anode side being in contact with the hydrogen-containing fuel, while the cathode side being in contact with oxygen in the air, the membrane electrode assembly (32) undergoing chemical reaction under the action of catalyst and directly generating power for output, the membrane electrode assembly (32) being disposed on the circuit board (30) and having a porous electrically conductive net on its left and right sides respectively as the power collector network for power output; the moisture sensor unit (34) comprises a first sensing member (340) and a second sensing member (342), the first sensing member (340) being disposed on one side of the circuit board (30), while the same side of the circuit board (30) having the plate body (42) disposed thereon, the second sensing member (342) being arranged on the plate body (43) and parallel to the first sensing member (340) to produce together capacitance effect; and a temperature sensor unit (36) made of conductive metal material to form an electrical construction with resistance effect or a heat-sensitive resistor and disposed on the circuit board (30).

The equivalent resistor in the temperature sensor unit (36) can be a conductive line made of metallic material, such as aluminum, gold or copper, or a high-resistance circuit made of metallic material, such as nickel or chromium. Take the example of conductive line, the temperature sensor unit (36) is made of common printed circuit board or formed by etching that endows the temperature sensor unit (36) considerable resistance property. Based on the interdependence between the resistance of its conductive line and temperature, the temperature sensor unit (36) obtains the temperature surrounding it by sensing the resistance of the conductive line. In addition, higher resistance of the temperature sensor unit (36) can enhance the resolution of temperature sensing. Thus, the conductive line of the temperature sensor unit (36) can be disposed on the circuit board (30) in a circuitous manner to extend its length.

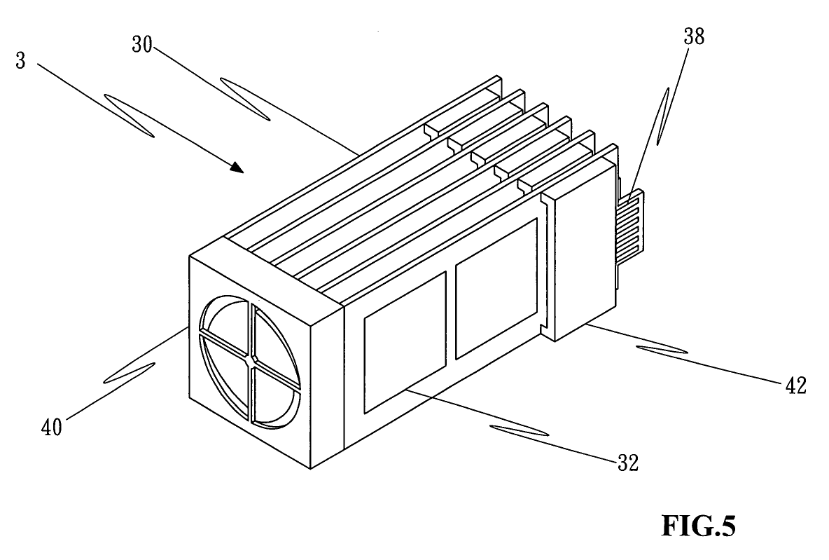

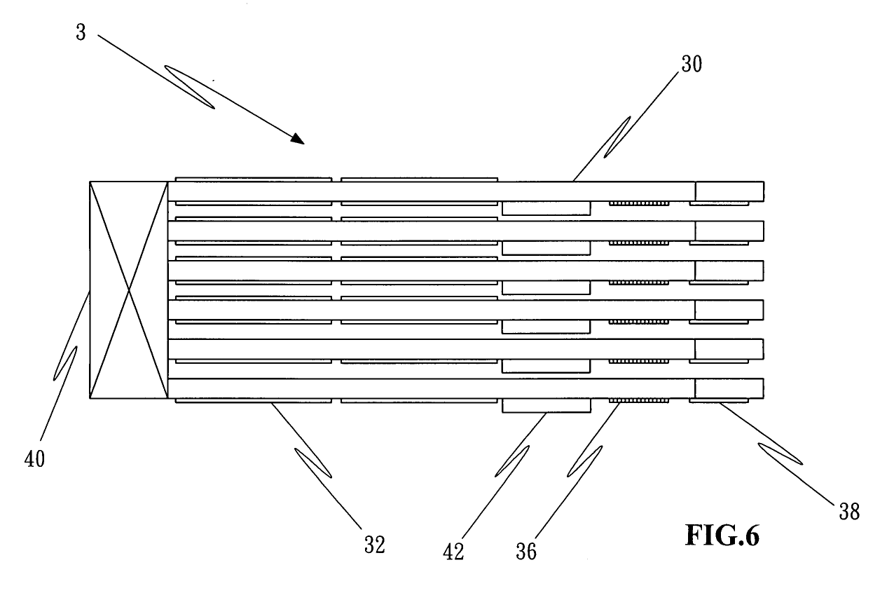

FIG. 5 is a perspective view of a fourth embodiment of the invention; FIG. 6 is a side view of FIG. 5. As shown, the fuel cell with moisture sensor device according to the invention further comprises a plurality of circuit boards (30) to form a power generation structure (3). The plurality of circuit boards (30) are parallel to each other and arranged in alternative stack to form the power generation structure (3), and a heat sink (40) is disposed at one end of the power generation structure (3) to provide active heat dissipation and the motive power for oxygen supply.

Moreover, the circuit broad (30) is extended with a connector (38) at one end. The connector (38) can transmit the signal on the change in capacitance and the change in resistance sent out by respectively the moisture sensor unit (34) and the temperature sensor unit (36). In the case where the heat sink (40) is a fan, an electric signal on the capacitance of the moisture sensor unit (34) and the resistance of the temperature sensor unit (36) as measured or processed is sent to the heat sink (40) via the connector (38). The heat sink (40) installed on one side of the circuit board (30) will adjust its fan speed based on the electric signal received to keep the overall moisture and temperature within a range.

The electric signal on the capacitance of the moisture sensor unit (34) or the resistance of the temperature sensor unit (36) can also directly regulate the fan speed of the heat sink (40) through a common electric loop, thereby regulating the moisture and temperature of the power generation structure (3).

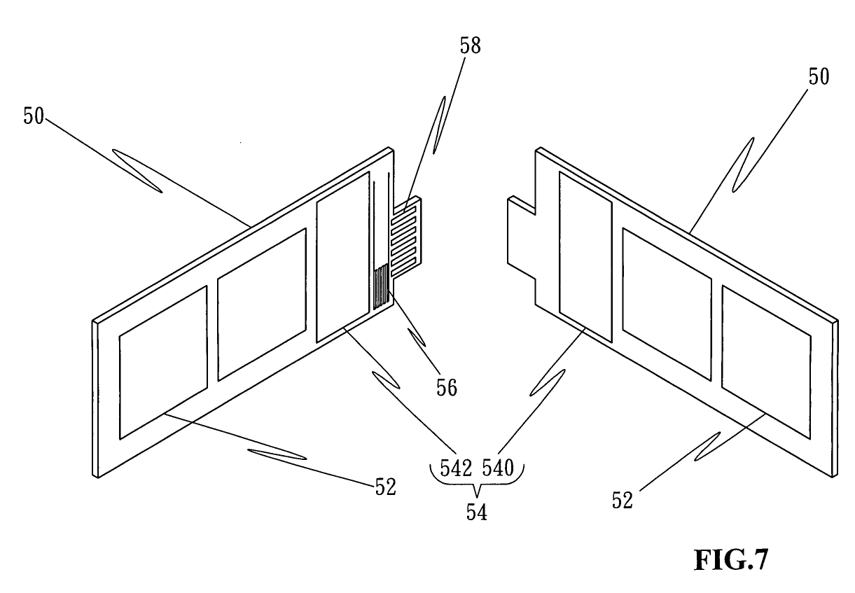

FIG. 7 is a perspective view of a fifth embodiment of the invention. The fuel cell having moisture sensor device according to the invention comprises a circuit board assembly (50) consisting of a first circuit board (500) and a second circuit board (502), the first circuit board (500) and the second circuit board (502) being parallelly arranged and at least a membrane electrode assembly (52), a moisture sensor unit (54), and a temperature sensor unit (56) arranged on the circuit board assembly (50). The circuit board assembly (50) is a common circuit board; the membrane electrode assembly (52) is the core power generation component of the fuel cell and a polymer membrane coated with platinum (Pt)-containing catalyst on the two side surfaces to form anode and cathode, the anode side being in contact with the hydrogen-containing fuel, while the cathode side being in contact with oxygen in the air, the membrane electrode assembly (52) undergoing chemical reaction under the action of catalyst and directly generating power for output, the membrane electrode assembly (52) being disposed on the circuit board assembly (50) and having a porous electrically conductive net on its left and right sides respectively as the power collector network for power output; the moisture sensor unit (54) comprises a first sensing member (540) and a second sensing member (542), the first sensing member (540) being disposed on one side of the first circuit board (500), while the second sensing member (542) being disposed on one side of the second circuit board (502) that opposes the side of the first circuit board (500) on which the first sensing member (540) is disposed, furthermore, the first sensing member (540) and the second sensing member (542) being parallel to each other to produce together capacitance effect; and a temperature sensor unit (56) made of conductive metal material to form an electrical construction with resistance effect or a heat-sensitive resistor and disposed on the circuit board assembly (50).

The equivalent resistor in the temperature sensor unit (56) can be a conductive line made of metallic material, such as aluminum, gold or copper, or a high-resistance circuit made of metallic material, such as nickel or chromium. Take the example of conductive line, the temperature sensor unit (56) is made of common printed circuit board or formed by etching that endows the temperature sensor unit (56) considerable resistance property. Based on the interdependence between the resistance of its conductive line and temperature, the temperature sensor unit (56) obtains the temperature surrounding it by sensing the resistance of the conductive line. In addition, higher resistance of the temperature sensor unit (56) can enhance the resolution of temperature sensing. Thus, the conductive line of the temperature sensor unit (56) can be disposed on the circuit board assembly (50) in a circuitous manner to extend its length.

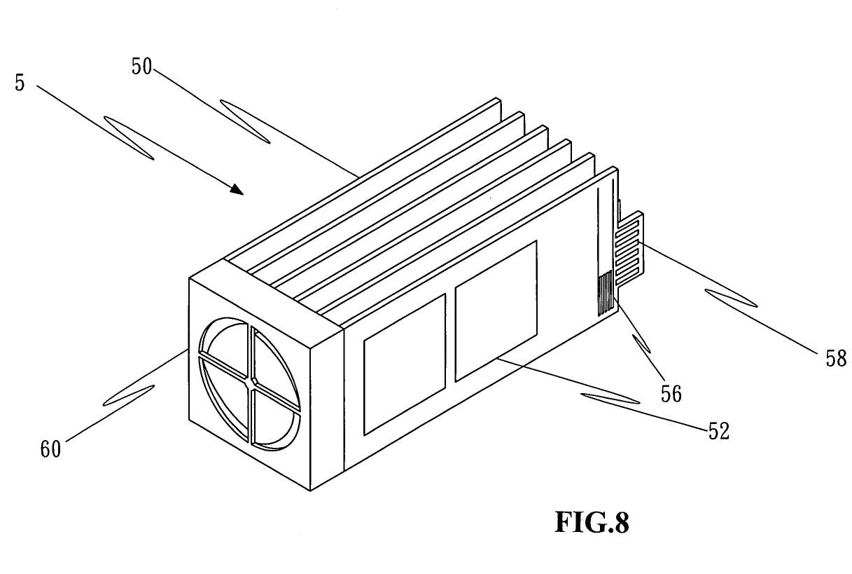

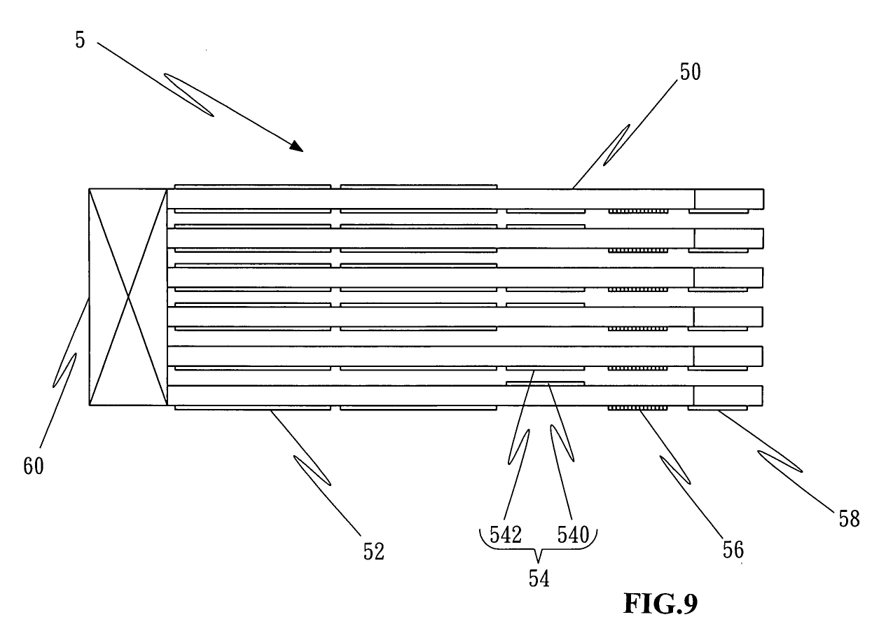

FIG. 8 is a perspective view of a sixth embodiment of the invention; FIG. 9 is a side view of FIG. 8. As shown, the fuel cell with moisture sensor device according to the invention further comprises a plurality of circuit board assemblies (50) to form a power generation structure (5). The circuit board assemblies (50) are parallel to each other and arranged in alternative stack to form the power generation structure (5), and a heat sink (60) is disposed at one end of the power generation structure (5) to provide active heat dissipation and the motive power for oxygen supply.

Moreover, the circuit broad assembly (50) is extended with a connector (58) at one end. The connector (58) can transmit the signal on the change in capacitance and the change in resistance sent out by respectively the moisture sensor unit (54) and the temperature sensor unit (56). In the case where the heat sink (60) is a fan, an electric signal on the capacitance of the moisture sensor unit (54) and the resistance of the temperature sensor unit (56) as measured or processed is sent to the heat sink (60) via the connector (58). The heat sink (60) installed on one side of the circuit board assembly (50) will adjust its fan speed based on the electric signal received to keep the overall moisture and temperature within a range.

The electric signal on the capacitance of the moisture sensor unit (54) or the resistance of the temperature sensor unit (56) can also directly regulate the fan speed of the heat sink (60) through a common electric loop, thereby regulating the moisture and temperature of the power generation structure (5).

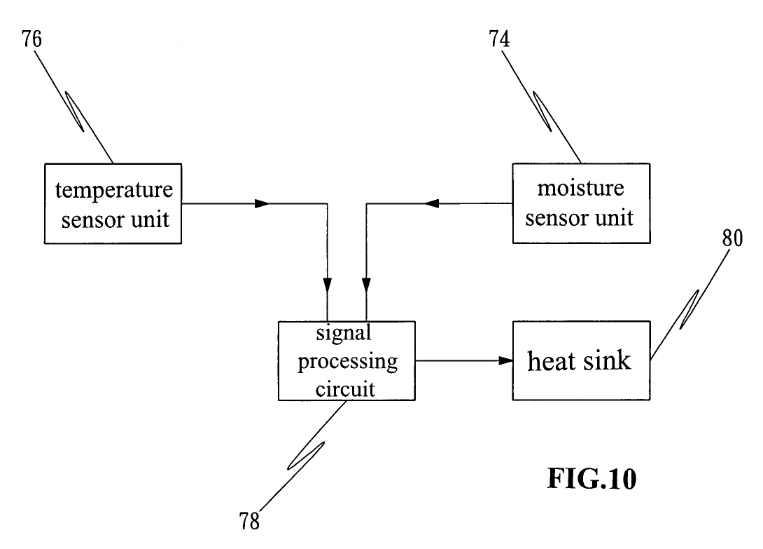

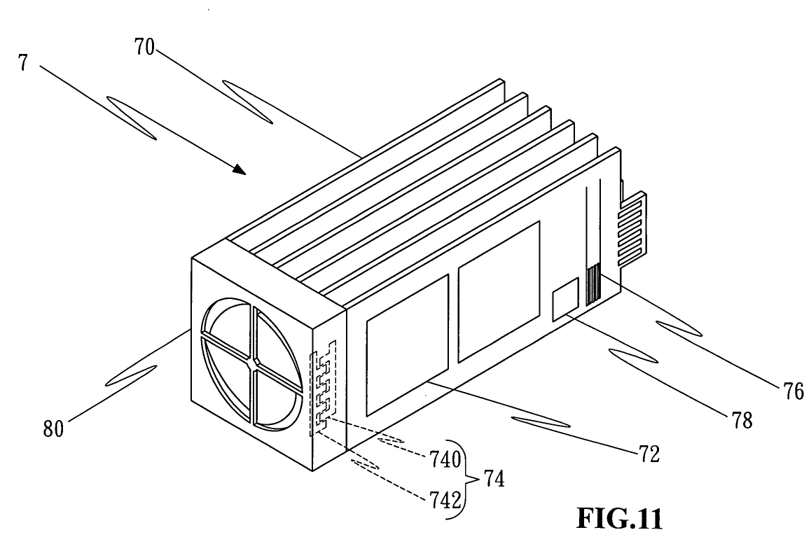

FIG. 10 is a circuit diagram of the invention; FIG. 11 is a perspective view of a seventh embodiment of the invention. As shown, the fuel cell having moisture sensor device according to the invention comprises a power generation structure as a source of power supply, the power generation structure (7) consisting of a plurality of circuit boards (70) alternately arranged in stack, wherein the circuit board (70) is a common circuit board and arranged with at least a membrane electrode assembly (72), the membrane electrode assembly (72) being the core power generation component of the fuel cell and a polymer membrane coated with platinum (Pt)-containing catalyst on the two side surfaces to form anode and cathode, the anode side being in contact with the hydrogen-containing fuel, while the cathode side being in contact with oxygen in the air, the membrane electrode assembly (72) undergoing chemical reaction under the action of catalyst and directly generating power for output, the membrane electrode assembly (72) having a porous electrically conductive net on its left and right sides respectively as the power collector network for power output; a signal processing circuit (78) disposed on the circuit board (70) of the power generation structure (7); a heat sink (80) dispose on one side of the power generation structure (7) and electrically connected to the signal processing circuit (78) to provide the power generation structure (7) with active heat dissipation; and a moisture sensor unit (74) consisting of a first sensing member (740) and a second sensing member (742), the first sensing member (740) and the second sensing member (742) being electrically connected to the signal processing circuit (78), and the moisture sensor unit (74) being disposed on the heat sink (80), and furthermore, in the airflow path inside the heat sink (80), the first sensing member (740) and the second sensing member (742) having respectively in horizontal direction a plurality of sidewardly extended strip lines that are alternately arranged to produce capacitance effect; and a temperature sensor unit (76) made of conductive metal material to form an electrical construction with resistance effect or a heat-sensitive resistor and disposed on the circuit board (70) of the power generation structure (7).

The equivalent resistor in the temperature sensor unit (76) can be a conductive line made of metallic material, such as aluminum, gold or copper, or a high-resistance circuit made of metallic material, such as nickel or chromium. Take the example of conductive line, the temperature sensor unit (76) is made of common printed circuit board or formed by etching that endows the temperature sensor unit (76) considerable resistance property. Based on the interdependence between the resistance of its conductive line and temperature, the temperature sensor unit (76) obtains the temperature surrounding it by sensing the resistance of the conductive line. In addition, higher resistance of the temperature sensor unit (76) can enhance the resolution of temperature sensing. Thus, the conductive line of the temperature sensor unit (76) can be disposed on the circuit board (70) in a circuitous manner to extend its length.

Moreover, the signal processing circuit (78) can transmit signal on the change in capacitance and the change in resistance sent out by respectively the moisture sensor unit (74) and the temperature sensor unit (76). In the case where the heat sink (80) is a fan, an electric signal on the capacitance of the moisture sensor unit (74) and the resistance of the temperature sensor unit (76) as measured or processed is sent to the heat sink (80) via the signal processing circuit (78). The heat sink (80) will adjust its fan speed based on the electric signal received to keep the overall moisture and temperature within a range.

The signal processing circuit (78) is installed on the power generation structure (7). In addition, it is able to receive electric signal on the capacitance of the moisture sensor unit (74) or the resistance of the temperature sensor unit (76) via a common electric loop to directly regulate the fan speed of the heat sink (80), thereby regulating the moisture and temperature of the power generation structure (7).

As such, the fuel cell having moisture sensor device provided by the invention employs a moisture sensor unit installed thereon to measure the change of moisture in the fuel cell. The invention possesses inventive step and meets the essential criteria for patent.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A fuel cell having moisture sensor device, the fuel cell having a power generation structure, and the power generation structure comprising:
a circuit board;
a membrane electrode assembly provided on the circuit board; and
a moisture sensor unit consisting of a first sensing member and a second sensing member, the first sensing member and the second sensing member being electrically connected to the circuit board, and together producing capacitance effect.

2. The fuel cell having moisture sensor device according to claim 1, wherein the first sensing member and the second sensing member are arranged on the circuit board.

3. The fuel cell having moisture sensor device according to claim 2, wherein the first sensing member and the second sensing member have respectively in horizontal direction a plurality of sidewardly extended strip lines that are alternately arranged.

4. The fuel cell having moisture sensor device according to claim 1, wherein the first sensing member being disposed on the circuit board, while the circuit board is coupled with a plate body, and the second sensing member is disposed on said plate body.

5. The fuel cell having moisture sensor device according to claim 1, wherein the circuit board further comprises a temperature sensing member, the temperature sensor member being consisted of any material selected from the group consisting of equivalent resistor and heat-sensitive resistor.

6. The fuel cell having moisture sensor device according to claim 5, wherein the equivalent resistor is selected from the group consisting of long lead circuit and high-resistance circuit.

7. The fuel cell having moisture sensor device according to claim 5, wherein the circuit board is electrically connected to a connector, the connector connecting the signals generated by the first sensing member, the second sensing member and the temperature sensing member to the exterior.

8. A fuel cell having moisture sensor device, the fuel cell having a power generation structure, the power generation structure comprising:
a first circuit board;
a second circuit board installed parallel to the first circuit board;
a membrane electrode assembly disposed on the first circuit board and the second circuit board; and
a moisture sensor unit consisting of a first sensing member and a second sensing member, the first sensing member and the second sensing member being electrically connected to the first circuit board and the second circuit board and producing capacitance effect.

9. The fuel cell having moisture sensor device according to claim 8, wherein the first sensing member and the second sensing member are respectively disposed on the first circuit board and the second circuit board, the first sensing member and the second sensing member being disposed respectively on the opposing surfaces of the first circuit board and the second circuit board.

10. The fuel cell having moisture sensor device according to claim 8, wherein the circuit board further consists of a temperature sensing member, the temperature sensing member being any material selected from the group consisting of equivalent resistor and heat-sensitive resistor.

11. The fuel cell having moisture sensor device according to claim 10, wherein the equivalent resistor is selected from the group consisting of long lead circuit and high-resistance circuit.

12. The fuel cell having moisture sensor device according to claim 10, wherein the circuit board is electrically connected to a connector, the connector connecting the signals generated by the first sensing member, the second sensing member and the temperature sensing member to the exterior.

13. A fuel cell having moisture sensor device, comprising:
a power generation structure being a source of power supply;
a signal processing circuit;
a heat sink disposed on one side of the power generation structure and electrically connected to the signal processing circuit; and
a moisture sensor unit consisting of a first sensing member and a second sensing member, the first sensing member and the second sensing member being electrically connected to the signal processing circuit and producing capacitance effect.

14. The fuel cell having moisture sensor device according to claim 13, wherein the first sensing member and the second sensing member are disposed on the heat sink.

15. The fuel cell having moisture sensor device according to claim 14, wherein the first sensing member and the second sensing member have respectively in horizontal direction a plurality of sidewardly extended strip lines that are alternately arranged.

16. The fuel cell having moisture sensor device according to claim 13, wherein the power generation structure further consists of a temperature sensing member, the temperature sensing member being any material selected from the group consisting of equivalent resistor and heat-sensitive resistor.

17. The fuel cell having moisture sensor device according to claim 16, wherein the equivalent resistor is selected from the group consisting of long lead circuit and high-resistance circuit.
